(19) United States
(12) Patent Application Publication
(10) Pub. No.: US 2002/0054141 A1
(43) Pub. Date: May 9, 2002

(54) Computer system for displaying multiple window displays

(76) Inventors: Hsiang Tsun Yen, Taipei (TW); Chien Sen Weng, Taipei (TW)

Correspondence Address: Michael D. Bednarek, SHAWPITTMAN, 1650 Tysons Boulevard, McLean, VA, 22102-4859, US

(21) Appl. No.: 09/908,772

(22) Filed: Jul. 20, 2001

(30) Foreign Application Priority Data
Nov. 3, 2000 (TW) 089123348

(51) Int. Cl. G06F 3/14

(52) U.S. Cl. 345/804; 345/781

(57) ABSTRACT

The invention provides a computer system for displaying multiple window displays adjacently and simultaneously. The computer system includes a display screen. When computer system executes the application program, it displays a graphical user interface (GUI) on the display screen. The GUI includes a plurality of window displays. The application program includes a plurality of window components. Each window component corresponds to a window display. Each window component includes an identity parameter for identifying window component and a display parameter for labeling the display status of the window display corresponding to a window component. When the display parameter is set as visible, the application program displays the window display corresponding to the window component. When display parameter is set as invisible, the application program does not display the window display corresponding to the window component.

### REFERENCE TO RELATED APPLICATIONS

This application program claims the benefit of priority under 35 U.S.C. § 119(a) of Taiwan Patent Application No. 089123348, filed Nov. 3, 2000.

### BACKGROUND OF THE INVENTION

1. Field of the Invention

This invention generally relates to a computer system and more particularly relates to a computer system for displaying multiple window displays adjacently and simultaneously.

2. Description of the Related Art

As is known in the prior art, a computer system for displaying multiple window displays permits users to execute single application program in multiple window displays. Nonetheless, those window displays cannot be viewed simultaneously on one screen. For the purpose to view each file in each window display, users have to go through inconvenient steps such as switching main displaying window displays, modifying the boundaries manually so as to reduce the display area of each window display and arranging those window displays to fit in one screen, or selecting the option “arrange all” from the application program menu to automatically arrange all window displays to be viewed simultaneously.

FIG. 1 is a schematic view, wherein a computer system 10 displays multiple window displays simultaneously after manual adjustment by a user. In application programs such as WordPad and NotePad from Microsoft, users open multiple window displays for different files. To realize the purpose to view multiple window display simultaneously, users can modify the boundaries manually so as to reduce the display area of each window display and arranging those window displays to be view simultaneously.

FIG. 2 is a schematic view, wherein a prior art computer system 12 automatically arranges all window displays to be viewed simultaneously by executing the option “arrange all” from the application program menu. For example, in the application program Acrobat Reader (a processor for PostScript/PDF files), users open multiple window displays to display different files. Users view multiple window displays simultaneously by selecting the option “Tile” (both horizontal and vertical tile viewing mode are available).

In a prior art computer system, although users can open multiple window displays when executing an application program, the display mode is designed based on a basis that users only deal with one file at one time. As a result, there is only one window display displaying on a screen for one file at one time. Provided users desired to process multi-files and in demand for multiple window displays simultaneously, the computer system can only provide users to open multiple window displays and to view files by switching display window displays are inconvenient for users.

When users open application program, prior art computer system only generates one window display for one file on one screen. If users are in demand for dealing with multiple files at one time, the users have to open multiple window displays for dealing with each file separately.

For example, if a user desire to deal with four files concurrently, the user is required to open four window displays. However, when the user closes the application program, the application program preference for the window display on that particular operation cannot be saved. The application program cannot save a preference where records users demand of displaying four window displays simultaneously.

As a result, as the user launch the application program next time, the application program will open a window display as default. The user then is required to open four files in four separate window displays and repeat the said steps to make four window displays displayed simultaneously to receive exactly the same result the user desired. In brief, the prior art computer system fails to meet the demand of displaying diversified information simultaneously and displaying multiple window displays.

Additionally, in the prior art computer system, when users browse websites with browsers, they often need to open multiple browser windows. Such occurs when users press a web page link on the viewing web page to download the other web page, some websites defaults to open said link in a new browser window. For example, if a user click a “check out” link, frequently a new browser window will be open to display the shopping list which is used for requesting the user to enter transaction related data such as user's name, delivery address, credit card number etc. Then the web page is returned to the server for completing user's order.

The other demand for the invention arises as users click on an email address link embedded on the web page. When a user click the email link button on the web page, the web site then sends request to the user's computer system for launching a new window display of a default email application program such as Microsoft Outlook in response to user's request.

When users are browsing websites with browsers, it often occurs that users need to open multiple browser windows for viewing different web pages or multiple email application program windows for viewing different emails. In practice, if users desire to do so, it is inconvenient for users either to switch displaying window displays or to modify boundaries manually and arrange those window displays to be displayed adjacently and simultaneously in one window display.

### SUMMARY OF THE INVENTION

The objective of the present invention is to provide a computer system providing a computer system for displaying multiple window displays adjacently and simultaneously so as to display diversified contents.

In a preferred embodiment, the present invention provides a computer system for displaying multiple window displays adjacently and simultaneously. The computer system includes a display screen. When computer system executes the application program, it displays a graphical user interface (GUI) on the display screen. The GUI includes a plurality of window displays. The application program includes a plurality of window components. Each window component corresponds to a window display. Each window component includes an identity parameter for identifying window component and a display parameter for labeling the display status of the window display corresponding to a window component. When the display parameter is set as visible, the application program displays the window display corresponding to the window component. When display parameter is set as invisible, the application program does not display the window display corresponding to the window component.

It is an advantage of the present invention that the computer system according to the invention delivers alternative presentation of information by displaying multiple window display adjacently and simultaneously. Users are permitted to view multiple window displays concurrently without extra operations such as switching for viewing different window displays with different information. In addition, users can arrange the order of the window displays as required. Even if window displays are belong to different application programs, simultaneous and adjacent multiple window displays can also be achieved by the invention.

These and other objectives of the present invention will no doubt become obvious to those of ordinary skill in the art after having read the following detailed description of the preferred embodiment, which is illustrated in the various figures and drawings.

### BRIEF DESCRIPTION OF DRAWINGS

The following detailed description, given by way of an example and not intended to limit the invention to the embodiments described herein, will best be understood in conjunction with the accompanying drawings, in which:

FIG. 1 is a schematic view wherein a computer system displays multiple window displays adjacently and simultaneously after manual adjustments by a user;

FIG. 2 is a schematic view wherein a prior art computer system displays all window displays adjacently and simultaneously in one screen display by executing the option “arrange all” from the application program menu;

FIG. 3 is a schematic view of the present invention;

FIG. 4a-c are schematic views illustrating steps wherein three window displays of the same application program are generated;

FIG. 5 is a schematic view of a stock ticker in a TV wall display style, and

FIG. 6a-e are schematic views according to the other embodiment of the invention.

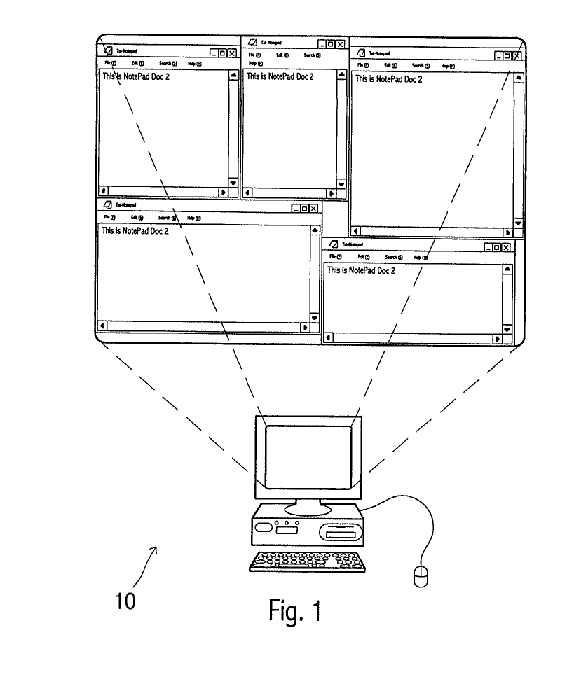

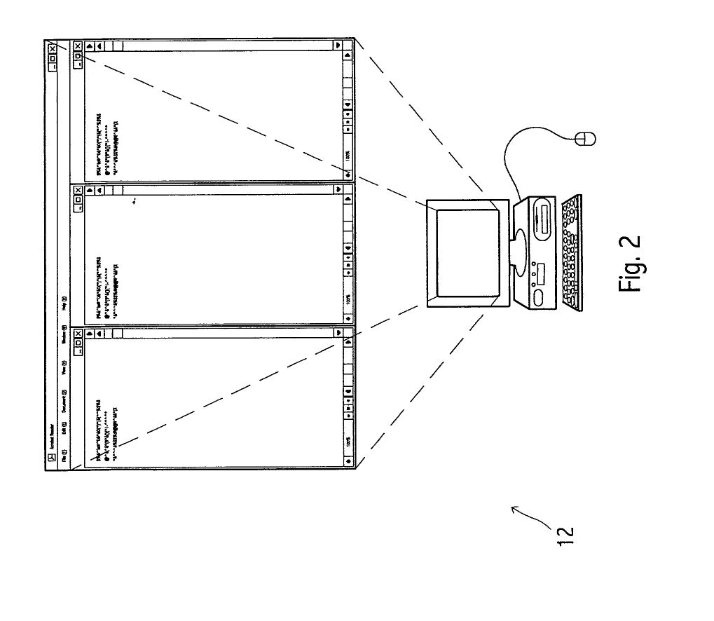

### DETAILED DESCRIPTION OF THE INVENTION

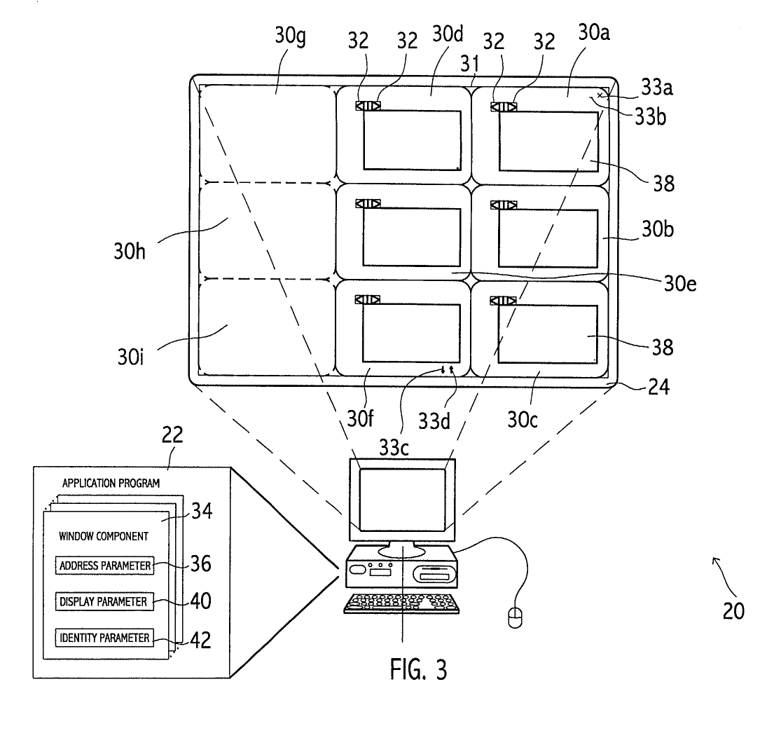

FIG. 3 is a schematic view of the present invention where a computer system 20 displays multiple window displays 30. The computer system 20 is used for executing an application program 22. The computer system 20 comprises a display screen 24 and input device 26, 28. The input device 26 is a keyboard and the input device 28 is a mouse. When the computer system 20 executes application program 22, the application program 22 generates a graphical user interface display 31 on display screen 24. The graphical user interface display 31 comprises a predetermined amount of window displays 30a-i (In the preferred embodiment of the invention, the predetermined amount of window displays are nine), and a plurality of function buttons 33. The function button 33 comprises a close function button 33a, a minimize function button 33b, a maximize function button 33c, and a restore function button 33d respectively. Each window display 30 comprises a display area 38 and a plurality of application program function buttons 32.

The application program 22 comprises a plurality of window components 34. Each window component 34 corresponds to a window display 30. Each window component 34 comprises a address parameter 36 for labeling the storage address of the displayed data in the display area 38 of the window display 30 corresponding to the window component 34, a display parameter 40 for labeling display status of the window display 30 corresponding to the window component 34, and a identity parameter 42 for labeling the display status of the window display 30 corresponding to the window component 34. When the display parameter 40 is set as visible, the application program 22 displays the window display 30 corresponding to the window component 34, and when the display parameter is set as invisible, the application program does not display the window display 30 corresponding to the window component 34.

Fading style method is one of the methods the application program 22 uses to display the window display 30, which generates a 2-dimentional effect. Inside-out style method is the other method for the application program 22 to display the window display 30, which generates a 3-dimensional effect.

The window displays 30 on the graphical user interface 31 are linked in an array based on the order of the identity parameters 42 of the window components 34. The window component 34 with a relatively lower identity parameter 42 subordinates to window component 34 with a relatively higher identity parameter 42. When a display parameter 40 of a window component 34 is set as invisible, the display parameter 40 of the next window component 34 in the array correspondingly and automatically set as invisible. In FIG. 3, window display 30a-i are linked in an array based on the order of the identity parameters 42 of the window components 34. The array follows a top-down and left to right order. For example, the window display 30b is subordinate to the window display 30a and the window display 30c is subordinate to the window display 30b respectively.

FIG. 3 illustrates the window display 30g-i (indicated as a dotted line), wherein the display parameter 40 is set as invisible. As a result, the application program 22 displays the window display 30a-f and does not display the window display 30g-l.

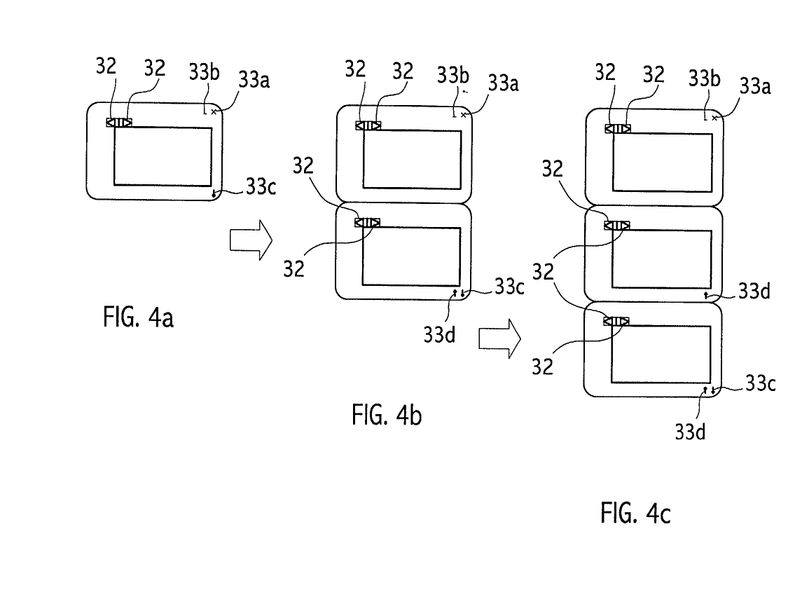

FIG. 4a-c are schematic views illustrating steps wherein the application program generates window displays 30a-c. When a user first launches the application program 22 in a computer system 20, the application program 22 generates the graphical user interface display 31 on the display screen 24. Concurrently, the application program 22 displays the window display 30a on the graphical user interface display 31. At the same time, only the display parameter 40 of the window display 30a is set as visible, the remaining other display parameters 40 are set as invisible. As a result, the application program 22 only displays window display 30a in response to set up of the display parameter. On the window display 30a, there are also a close function button 33a, a minimize function button 33b, and a extend function button 33c displayed on the window display 30a.

When a user selects the extend function button 33c with a mouse 28, the application program 22 displays window display 30b, shifts the extend function button 33c to the window display 30b and displays folding function button 33d on the window display 30b. As shown in the FIG. 3, the window display 30b lies next to the window display 30a and the window display 30b is subordinate to the window display 30a.

When a user selects the extend function button 33c, the set up of the display parameter 40 of the window display 30b is alternated from invisible to visible. As a result, the application program 22 displays the window display 30b.

In addition, when a user selects close function button 33a with a mouse 28 to close application program 22. Due to the fact that the-display parameter 40 of the window display 30a and the window display 30b is set as visible, when the user opens the application program 22 following the above, the application program 22 then displays both the window display 30a and window display 30b.

When a user selects the extend function button 33c on the window display 30b, the display parameter 40 of the window display 30c is alternated from invisible to visible. As a result, the application program 22 displays window display 30c, shifts the extend function button 33c to the window display 30c, and displays the folding function button 33d on the window display 30c.

When a user selects the folding function button 33d on the window display 30c with a mouse 28, the display parameter 40 of the window display window display 30c is alternated from visible to invisible. As a result, the application program 22 makes the window display 30c invisible by allowing the window display 30c as if it is folded under the window display 30b, and shifts the extend function button 33cto the window display 30b.

When a user selects the folding function button 33d on the window display 30b with a mouse 28, the display parameter 40 of the window display 30b and window display 30c are alternated from visible to invisible. As a result, the application program 22 makes the window display 30b and window display 30c invisible by allowing window display 30b and window display 30c as if they are folded under the window display 30b, and shifts the extend function button 33c to the window display 30a. Due to the fact that the window display 30c is subordinate to the window display 30b, when the display parameter 40 of the window display 30b is set as invisible, the set up of the display parameter 40 of the window display 30c is also invisible.

As shown in FIG. 4a, if a user closes the application program 22 by selecting a close function button 33a. The application program 22 close, the display parameter 40 of window display 30a-c is set as visible, consequently when user open application program 22 following the above, the application program 22 displays window display 30a-c.

The display parameter of the window display 30a is permanently set as visible. Folding function button is not available on the window display 30a. In other words, the application program 22 displays at least the window display 30a. When user launches the application program 22, it displays all window displays 30 on the graphical user interface display 31 having display parameter 40 setting as visible.

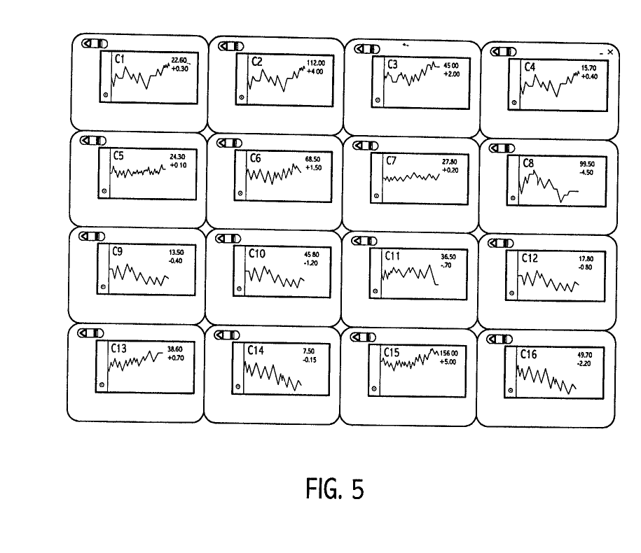

The application program 22 displays multiple window displays 30 adjacently and simultaneously. As shown in FIG. 5, the application program 22 is a stock ticker application program for reporting real-time stock list. The extend function button 33c of the application program 22 allows users to generate window display 30 (according to FIG. 3, a maximum of the displays is up to nine window displays on one screen). In addition, adjacently arranged multiple window displays deliver a vision effect similar to a TV wall.

The computer system 20 is linked to a server via a network (neither shown in the diagrams). The computer system 20 downloads stocks data from the server and displays the data in the display region of the window display. By selecting the function button 32, users are allowed to view different data displayed in the display region of the application program.

An example of the above is described as follows. When a user selects a application program function button 32 of window display 30, the application program 22 generates a dialogue box for the user to make a request by entering desired listed company. It follows that the data is returned to the server. In respond to the user's request, the server send the data of the stocks quote for user's desired company real-time to the computer system and the computer systems then displays the data on the window display. That indicates through alternating the address parameter 36 of a window display, computer system 20 is allowed to received different data from different storage locations.

When a user closes the application program 22 by selecting the close function button 33a, the computer system 20 saves the display parameter and the address parameter of each window display. When the user opens the application program 22 subsequently, computer system 20 then displays all window display with the display parameter set up as visible and downloads the data based on the address parameter saved. For example, when a user closes an application program, the application program displays three window displays on the screen. The content of the window displays are stock list of Company 1, Company 2 and Company 3. Provided that the user subsequently opens application program, the application program then displays exactly the same window displays, which are stock list of Company 1, Company 2 and Company 3.

The combination of the stock ticker application program and the present invention realizes a multiple window display for stock list report. Users are allowed to receive real-time stock list report in a TV wall style by said combination. The application program 22 retrieves data of the storage apparatus (not shown in the diagrams) in the computer system 20 and the data then is displayed in the display area 38 of the window display 30. For example, the application program 20 is a spreadsheet application program, which retrieves data from a storage apparatus. Therefore, the application program 20 serves to offer multiple window displays on one screen, which allows users to view multiple spreadsheets window displays at one time.

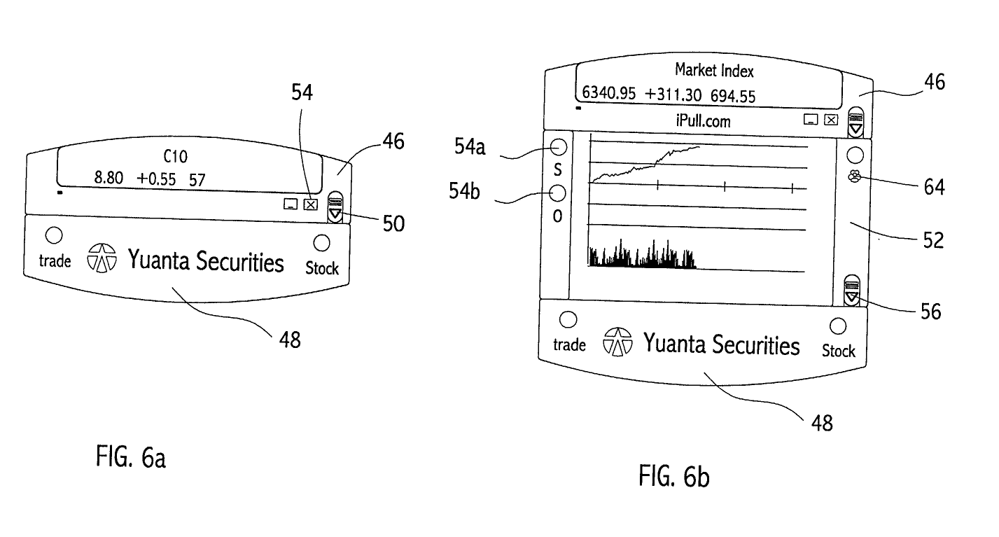

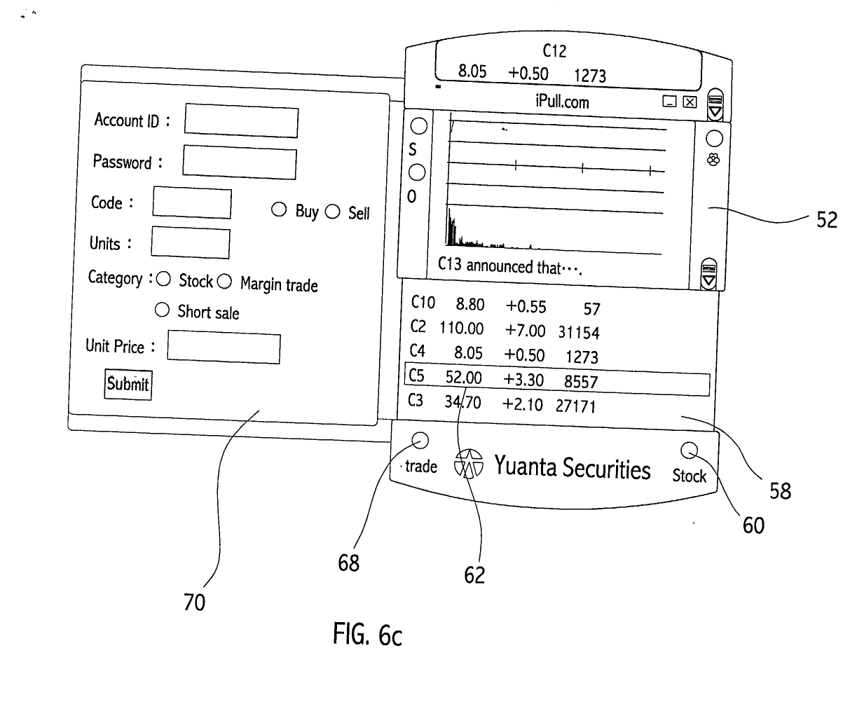

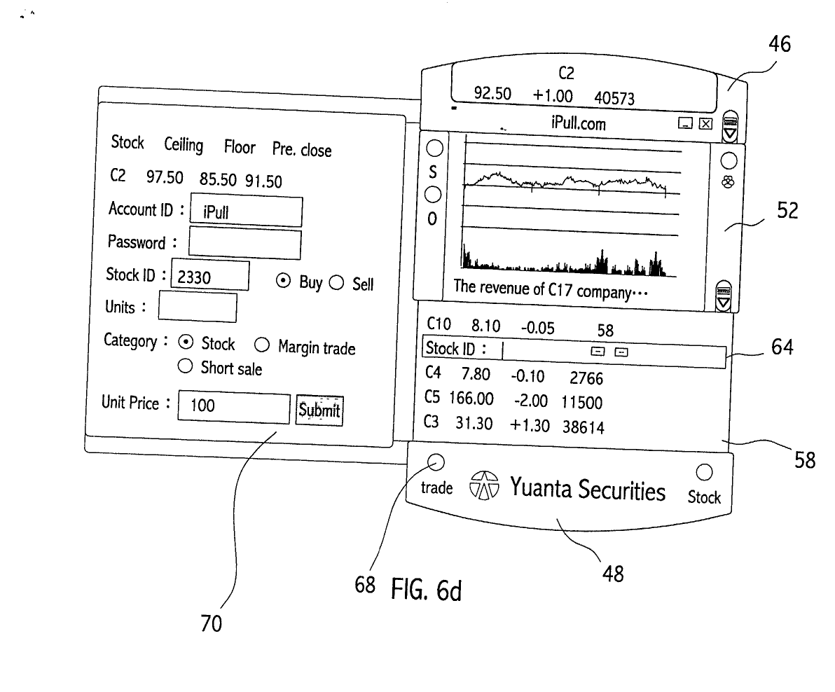

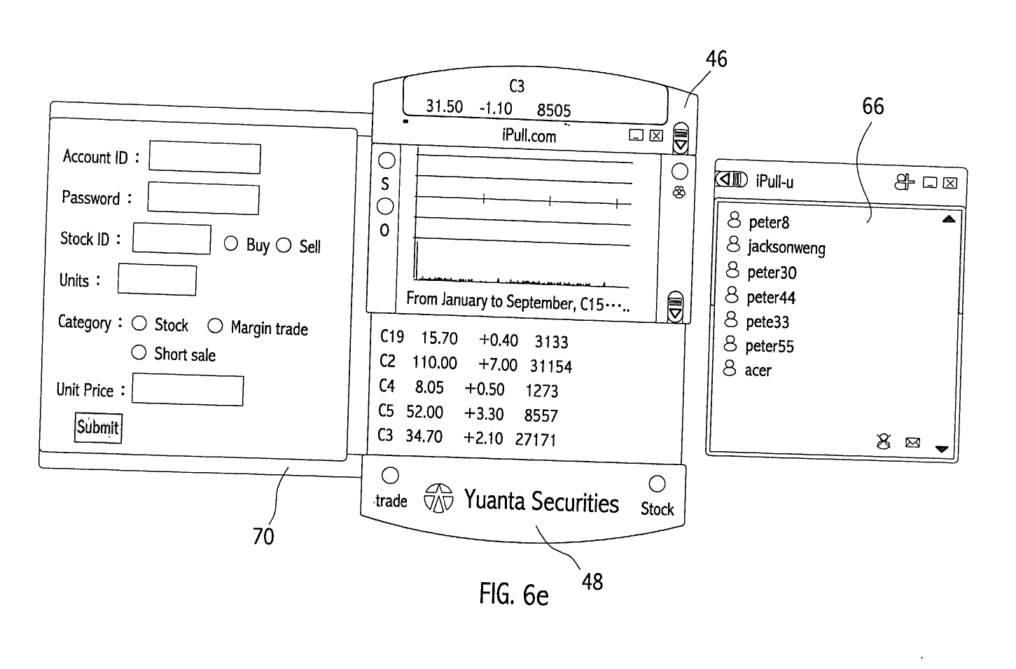

FIG. 6a-e are schematic views according to the other embodiment of the invention. An application program 44 generates multiple window displays, and arranges them adjacently. The differences between the application program 44 and the application program 22 is the purpose of practices for each application program.

The main feature of the application program 44 is the multiple displays of a browser. The application program 44 serves as an online stockbroker, which also offers online stock list. The application program 44 and the application program 22 can be integrated together as a new application program, wherein the application program 22 is used for generating the stock ticker in TV wall display style and the application program 44 is used to complete an stock online transaction.

Refers to FIG. 6a, when the computer system 20 opens application program 44, it displays a first main window display 46 at a first predetermined location on the display screen 24 and a second main window display 48 at a second predetermined location on the display screen 24. The second predetermined location corresponds to the first predetermined location and the second main window display 48 are enabled to link adjacently to the first main window display 46. The display parameter of the window component corresponding to the first main window display 46 and the second main window display 48 is permanently set as visible. As a result when the application program 44 is opened, the first main window display 46 and the second main window display 48 are always displayed on the display screen.

When a user selects the first main window control button 50 on the window display 46 with a mouse 28, the application program 44 displays the first sub-window display 52 at the second predetermined location on the display screen 24. The second predetermined location is in relation to the first predetermined location The first sub-window display 52 is enabled to link adjacently to the first main window display 46. The display of the second main window display 48 shifts to a third predetermined location according to the size of the first sub-window display 52, the second main window display 48 is enabled to link to the first sub-window display 52.

When a user selects the window control button 50 on the first main window display 46 with a mouse 28, the display parameter of the window component of the first sub-window display 52 is alternated from invisible to visible. The first sub-window display 52 then is displayed at the location where the second main window display 48 previously was. As a result, the application program 44 determines a new display location for the second main window display 48 based on the size such height and width of the first sub-window display 52, so as to enable the first main window display 46, first sub-window display 52 and the second main window display 48 to link adjacently.

According to the preferred embodiment, the computer system 20 is linked to the server via a network. The computer system 20 downloads real-time stock information. As shown in the diagram, the first main window display 46 and the first sub-window display 52 both comprise a display region for displaying stock information. When a user selects the application program function button 54a, a stock list is displayed in the display region of the first main window display 46 and a stock market curve is displayed on the first sub-window display 52. Data displayed in the first main window display 46 and the display region of the first sub-window display 52 is interrelated. When data displayed on the first main window display 46 changes, the content of data on the first sub-window display 52 also a correspondingly changes. When a user selects the application program function button 54b, an OTC (over the counter) stock list is displayed in the display region of the first main window display 46 and a OTC stock market curve is displayed on the first sub-window display 52.

When the user open select window control button 50 consequentially, the display parameter of the first sub-window display 52 is alternated from visible to invisible and accordingly closes first sub-window display 52. The display of the second main window display 48 then shifts from the third predetermined location to the second predetermined location.

In the FIG. 6b, the second main window display 48 and the first sub-window display 52 are subordinate to the first main window display 46. Therefore, when first main window display 46 shifts, the second main window display 48 and the first sub-window display 52 also shift correspondingly so as to enable the first main window display 46, the first sub-window display 52 and the second main window display 48 remaining adjacently linking together. When a user closes the first main window display by selecting close the function button 54, the operation also causes the second main window display 48 and the first sub-window display 52 to close.

In the FIG. 6b, when a user selects the window control button 56 on the first sub-window display 52, the application program 44 displays the second sub-window display 58 at the third predetermined location on the display screen 24, so as to enable the second sub-window display 58 to link adjacently first sub-window display 52. The third predetermined location is in relation to the second predetermined location The application program 44 shifts the second main window display 48 to a fourth predetermined location based on the size of the second sub-window display 58, so as to enable the second main window display 48 to link adjacently to the second sub-window display 58. Refers to FIG. 6c, the displays of the first main window display 46, the first sub-window display 52, the second sub-window display 58 and the second main window display 48 are linked adjacently.

When a user selects the window control button 56 on the first sub-window display 52, the display parameter of the second sub-window display 58 is set as invisible and accordingly closes the second sub-window display 58. The display of the second main window display 48 then shifts to the third predetermined location.

The second sub-window display 58 is subordinate to first sub-window display 52. When a user selects the window control button 50 of the first main window display 46, the display parameter of the first sub-window display 52 and the second sub-window display 58 is set as invisible and therefore closes first sub-window display 52 and the second sub-window display 58 simultaneously. The display of the second main window display 48 then shifts to the second predetermined location (refers to FIG. 6a).

Refers to FIG. 6c, when a user selects a specific stocks data function button 60 on the second main window display 48, the displayed data on the second sub-window display 58 changes. In other words, when a user selects the specific stocks data function button 60 on the second main window display 48, the application program 44 changes the address parameter of the second sub-window display 58, as a result the computer system 20 downloads data from a different storage address.

The function buttons on a window display users control permit users to control the display status of a window display (i.e. a window control button) and displayed data on a window display (i.e. a specific stocks data function button).

By selecting a data item 62 on the second sub-window display 58, users are offered choices of different data i.e. various stocks data for desired listed companies. For example, when a user selects an option on the data item 62 titled ABC Company, the application program 44 then displays a third sub-window display 64 at the fifth predetermined location (refers to FIG. 6d). In other words, the display parameter of the third sub-window display 64 is set as visible after the operation. Such enables the third sub-window display 64 displays on top of the second sub-window display 58. The third sub-window display 64 is a dialogue box. The user can enter a code for another listed company.

Thereafter the code is returned to the server and so as to enable the server to send the data corresponding to the code for the listed company, which the user entered. The data is displayed on the third sub-window display 64. As a result, the application program 44 sets the display parameter of the third sub-window display 64 as invisible. Consequently, previous displayed data of ABC Company is substituted by the data of the stock list selected by the user.

The second sub-window display 58 comprises a plurality of data items 62. Each data item 62 is regarded as a sub-window display. Users can substitute the data of any sub-window display by alternating the address parameter of the sub-window display. Such that the computer system 20 links to different storage apparatus, retrieves various data and displays the data on the sub-window display.

When a user selects a trade function button 68 on the second main window display 48, the application program 44 displays a fifth sub-window display 70 on the display screen 24. The fifth sub-window display 70 is in relation to the first predetermined location of the first main window display 46. Such operation enables the fifth sub-window display 70 adjacently to link to the first main window display 46 (refers to FIG. 6d). As the embodiment shows, the fifth sub-window display 70 is a dialogue box for trading. With fifth sub-window display 70, the user completes an Internet trading of stocks.

Furthermore, multiple window displays displayed by the computer system 20 on the display screen 24 can be window displays from different application programs. In the preferred embodiment, when a user selects an email function button 67 on the first sub-window 52, the computer system 20 executes a corresponding email application program (not shown in the diagrams).

The email application program displays a fourth sub-window display 66 on the display screen 24 at a sixth predetermined location in relation to the first main window display 46. This enables the fourth sub-window display 66 to link adjacently to the first main window display 46 (refers to FIG. 6e). Users can access to email service by the email application program. The email application program and the application program 44 are not correlated. Consequentially, when user closes the application program 44, the operation does not close the email application program.

However, the fourth sub-window display 66 is subordinate to the first main window display 46, when the first main window display 46 shifts, the fourth sub-window display 66 also shifts correspondingly. Thus the fourth sub-window display 66 is always linked to the first main window display 46. In other words, through modularizing design of the window display, even if window displays are generated from application program, those window displays can be located adjacently on a display screen.

Fading style method is one of the methods for the application program 44 to display a window display (either a main window display or a sub-window display), which generates a 2-dimentional effect. Reverse style method is the other method for the application program 44 to display a window display, which generates a 3-dimensional effect.

To compare the invention with prior art, the computer system according to the invention delivers alternative presentation of information by displaying multiple window display adjacently and simultaneously. Users are permitted to view multiple window displays concurrently without extra operations such as switching for viewing different window displays with different information. In addition, users can arrange the order of the window displays as required. Even if window displays are belong to different application programs, simultaneous and adjacent multiple window displays can also be achieved by the invention.

While the invention has been described with reference to various illustrative embodiments, the description herein should not be construed in a limiting sense. Various modifications of the illustrative embodiments, as well as other embodiments of the invention, will be apparent to those skilled in the art upon reference to this description. It is therefore contemplated that the appended claims will cover any such modifications or embodiments as may fall within the scope of the invention defined by the following claims and their equivalents.

What is claimed is:

1. A method for displaying a plurality of window displays in a computer system including a display screen and at least one input device, the method comprising the steps of:
displaying a first window display at a first predetermined location on the display screen;
executing a predetermined launching object in the first window display with the input device by a user;
displaying a second window display at a second predetermined location on the display screen and enabling the second window display to link adjacently to the first window display at the first predetermined location; and
wherein the second window display subordinates to the first window display, when the first window display shifts, the second window display shifts correspondingly and when the first window display is closed with the input device, the second window display closes correspondingly.

2. The method of claim 1, wherein after the user closes the first window display and correspondingly closes second window display with the input device, when the computer system displays the first window display next time, the computer system correspondingly displays the second correspondingly window display.

3. The method of claim 1, wherein the first and the second window display both comprise a display region for displaying data.

4. The method of claim 3, wherein the computer system is linked to a server via a network, the computer system downloads data from the server and displays the data in the display region.

5. The method of claim 3, wherein the computer system further comprises a storage apparatus, the computer system retrieves data from the storage apparatus and displays the data in the display region.

6. The method of claim 3, wherein the data displayed in the display region in the first and the second window display are correlated, when the data of the first window display changes, the data of the second window display changes correspondingly.

7. A computer system for executing an application program, the computer system having a display screen, when the computer system executes the application program the computer system displays a graphical user interface in the display screen, the graphical user interface having a plurality of window displays, the application program having a plurality of window components, wherein each window component corresponds to a window display, and each a window component comprising:
an identity parameter for identifying the window component;
a display parameter for labeling the display status of the window display corresponding to the window component, wherein when the display parameter is set as visible, the application program displays the window display corresponding to the window component, and when the display parameter is set as invisible, the application program does not display the window display corresponding to the window component;
wherein the window displays corresponding to window components, on the graphical user interface are linked in an array based on the order of the identity parameters of the window components, the window component with a relatively lower identity parameter subordinates to window component with a relatively higher identity parameter, when the display parameter of a window component is set as invisible, the display parameter of the next window component in the array correspondingly and automatically set as invisible; and
wherein display parameter of the window component which is the first identity parameter in the array is always set as visible, when the computer system launches the application program, the application program displays all window display corresponding to the window component having display parameter setting as visible on the graphical user interface.

8. The computer system of claim 7, wherein the computer system further comprises at least one input device enabling a user to set the display parameters of the window components.

9. The computer system of claim 7, wherein the window display comprises a display region for displaying data.

10. The computer system of claim 9, wherein the computer system is linked to a server via a network, the computer system downloads data from the server and displays the data in the display region.

11. The computer system of claim 9, wherein the computer system further comprises a storage apparatus, the computer system retrieves data from the storage apparatus and displays the data in the display region.

12. The computer system of claim 9, wherein the data of at least two window displays are correlated, when the data of the first window display changes, the data of the second window display changes correspondingly.

13. A method for displaying a plurality of window displays in a computer system including a display screen and at least one input device, the method comprising the steps of:
displaying a first main window display at a first predetermined location and a second main window display at a second predetermined location on the display screen, wherein the second predetermined location corresponds to the first predetermined location enabling the second main window display to link to the first main window display;
executing a predetermined launching object in the first main window display with the input device by a user;
displaying a first sub-window display at a second predetermined location corresponding to the first predetermined location on the display screen, enabling the first sub-window display to link to the first main window display, the second main window display shifting to a third predetermined location based on the dimension of the first sub-window display enabling the second main window display to link to the first sub-window display;
wherein when the user closes the first sub-window display with the input device, the second main window display shifts to fill the second predetermined location; and
wherein the second main window display and the first sub-window display subordinate to the first main window display, when the first main window display shifts, the second main window display and the first sub-window display correspondingly shift, and when the user closes the first main window display with the input device, the second main window display and the first sub-window display correspondingly closes.

14. The method of claim 13, wherein when the user executes a predetermined launching object in the first sub-window display with the input device, a second sub-window display is displayed at a third predetermined location corresponding to the second predetermined location on the display screen, enabling the second sub-window display to link to the first sub-window display, the second main window display shifts to a fourth predetermined location based on the dimension of the second sub-window display enabling the second main window display to link to the second sub-window display, when the user closes the second sub-window display with the input device, the second main window display shifts to fill the third predetermined location, the second sub-window display subordinates to the first sub-window display, when the first sub-window display shifts, the second sub-window display shifts, and when the user closes the first sub-window display with the input device, the second sub-window display closes correspondingly and the second main window shifts to a second predetermined location.

15. The method of claim 13, wherein when the user executes a predetermined launching object in the first main window display with the input device, a second sub-window display is displayed at a fourth predetermined location corresponding to the first predetermined location on the display screen, enabling the second sub-window display to link to the first main window display, the second sub-window display subordinates to the first main window display, when the first main window display shifts, the second sub-window display correspondingly shifts, and when the user closes the first main window display with the input device, the second sub-window display correspondingly closes.

16. The method of claim 13, wherein when the user executes a predetermined launching object in the first sub-window display with the input device, a second sub-window display is displayed at a second predetermined location corresponding to the second predetermined location on the display screen, enabling the second sub-window display to link to the first sub-window display, the second sub-window display subordinates to the first sub-window display, when the first sub-window display shifts, the second sub-window display correspondingly shifts, and when the user closes the first sub-window display with the input device, the second sub-window display correspondingly closes.

17. The method of claim 13, wherein when the user executes a predetermined launching object in the second main window display with the input device, a second sub-window display is displayed on the display screen corresponding to the first predetermined location, enabling the second sub-window display to link to the first main window display, the second sub-window display subordinates to the second main window display, and when the user closes the second main window display with the input device, the second sub-window display correspondingly closes.

18. A computer system for executing an application program, the computer system having a display screen, when the computer system executes the application program the computer system displays a graphical user interface in the display screen, the graphical user interface having a plurality of window displays, each window display having a display area for displaying data, the application program having a plurality of window components, and each window component corresponding to a window display and comprising a address parameter for labeling the storage address of the displayed data in the display area of the window display corresponding to the window component.

19. The computer system of claim 18, wherein the computer system is linked to at least one server via a network, the storage address is the location of the server, the computer system downloads data corresponding to the storage address based on the address parameter from the server and displays the data in the display region of the window display.

20. The computer system of claim 18, wherein the computer system further comprises a storage apparatus, the storage address is the location of the storage apparatus, the computer system retrieves data corresponding to the storage address based on the address parameter from the storage apparatus and displays the data in the display region of the window display.

21. The computer system of claim 18, wherein the data of at least two window displays are correlated, when the data of the first window display changes, the data of the second window display changes correspondingly.

22. A method for displaying a plurality of window displays in a computer system including a display screen and at least one input device, the method comprising the steps of:
executing a first application program displaying a first window display at a first predetermined location on the display screen;
executing a predetermined launching object in the first window display with the input device by a user;
executing a second application program and displaying a second window display at a second predetermined location on the display screen and enabling the second window display to link adjacently to the first window display at the first predetermined location; and
wherein when the first window display shifts, the second window display shifts correspondingly.
